(19) United States
(12) Patent Application Publication
(10) Pub. No.: US 2014/0123031 A1
(43) Pub. Date: May 1, 2014

(54) METHOD AND SYSTEM FOR CALCULATION AND UTILIZATION OF VARIOUS USER PERSONAS

(71) Applicant: Richard Postrel, Miami Beach, FL (US)

(72) Inventor: Richard Postrel, Miami Beach, FL (US)

(21) Appl. No.: 14/036,378

(22) Filed: Sep. 25, 2013

Related U.S. Application Data
(60) Provisional application No. 61/705,186, filed on Sep. 25, 2012.

(51) Int. Cl. H04L 29/06; G06F 3/0484

(52) U.S. Cl. CPC H04L 65/403; G06F 3/0484
USPC 715/753

(57) ABSTRACT

Provided is a method for generating a plurality of user personas comprising the steps of a user inputting, via a user computer, user input data associated with the user; transmitting the user input data to a persona server computer; the persona server computer accessing a plurality of external data sources to obtain external user data associated with the user; the persona server computer using the user input data and the external user data to calculate an actual persona of the user, an internal perceived persona of the user, an external perceived persona of the user, and an aspirational persona of the user; the persona server computer sending the actual persona of the user, the internal perceived persona of the user, the external perceived persona of the user, and/or the aspirational persona of the user to the user computer for display to the user.

### BACKGROUND OF THE INVENTION

This invention relates to a method and system for calculating and utilizing various user personas based on various input data, and in particular to such a system that calculates and utilizes an actual persona, an internal perceived persona, an external perceived persona, and an aspirational persona.

### SUMMARY OF THE INVENTION

Provided is a method for generating a plurality of user personas comprising the steps of a user inputting, via a user computer, user input data associated with the user; transmitting the user input data to a persona server computer; the persona server computer accessing a plurality of external data sources to obtain external user data associated with the user; the persona server computer using the user input data and the external user data to calculate an actual persona of the user, an internal perceived persona of the user, an external perceived persona of the user, and an aspirational persona of the user; the persona server computer sending the actual persona of the user, the internal perceived persona of the user, the external perceived persona of the user, and/or the aspirational persona of the user to the user computer for display to the user.

A persona diagram may be generated that illustrates a graphical relationship between the actual persona of the user, the internal perceived persona of the user, the external perceived persona of the user, and/or the aspirational persona of the user, and sending the personal diagram to the user computer for display to the user.

The user may upon viewing the personas revise the user input data and transmit the revised user input data to the persona server computer. The persona server computer then uses the revised user input data to revise the actual persona of the user, the internal perceived persona of the user, the external perceived persona of the user, and/or the aspirational persona of the user; and the persona server computer sends the revised actual persona of the user, the revised internal perceived persona of the user, the revised external perceived persona of the user, and/or the revised aspirational persona of the user to the user computer for display to the user.

### BRIEF DESCRIPTION OF THE DRAWING

FIG. 1 is a diagram of the overlapping features of the various user personas that are subject of this invention.

FIG. 2 is a basic block diagram of the preferred embodiment of the present invention.

FIGS. 3 and 4 illustrate an example of a dashboard user interface of the preferred embodiment of the present invention.

FIG. 5 is a flowchart of the operation of the invention.

### DESCRIPTION OF THE PREFERRED EMBODIMENTS

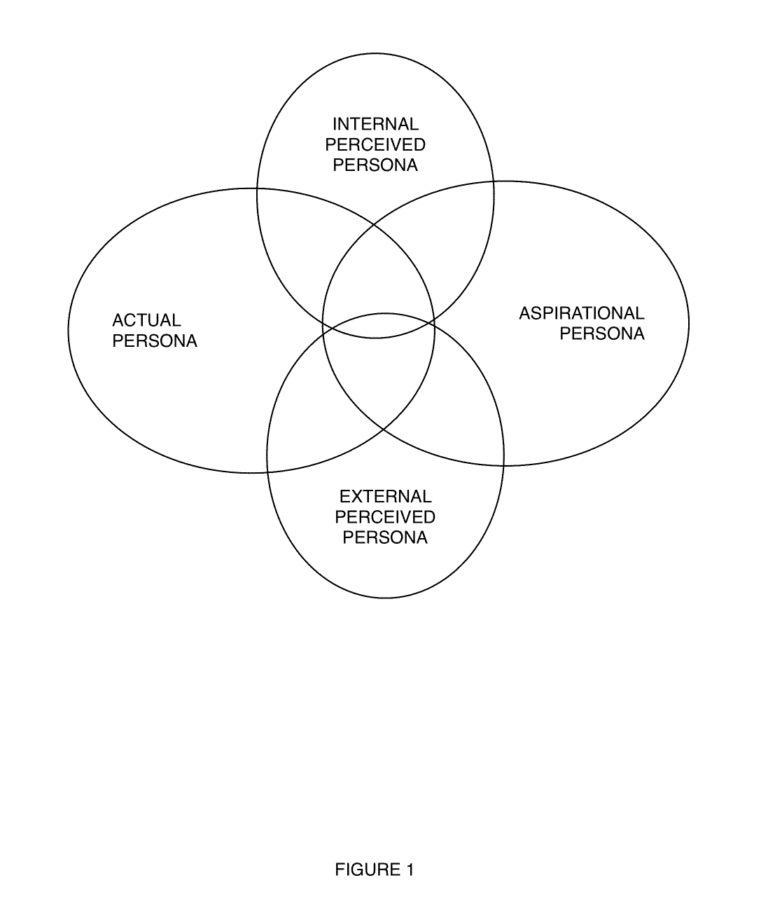

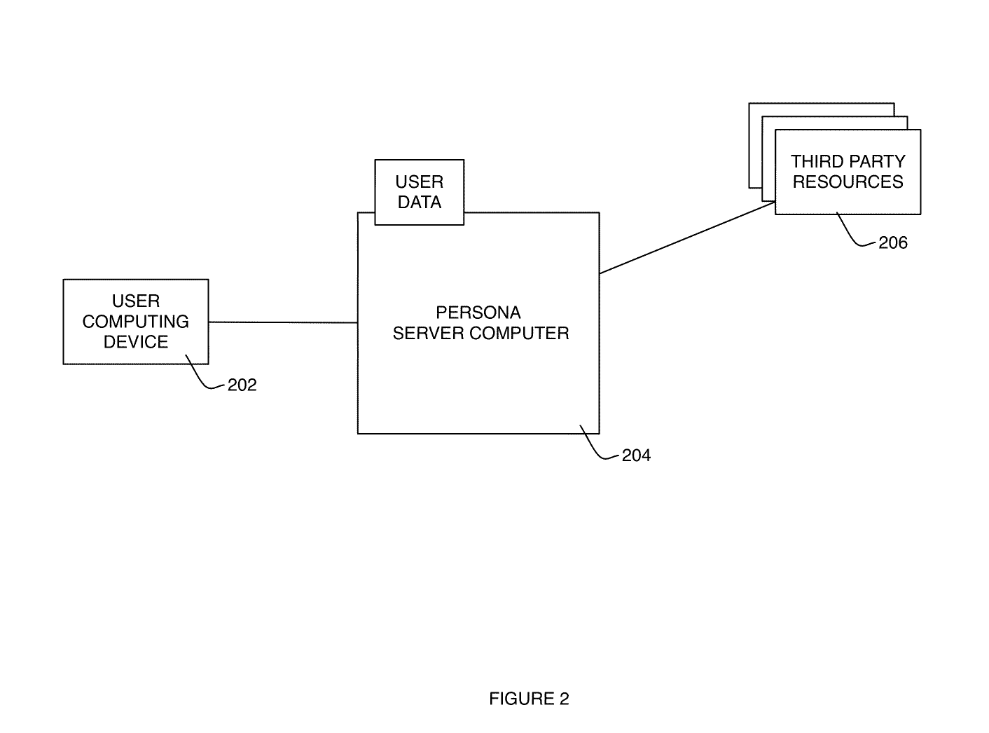

In accordance with the present invention, a user has various personas as defined herein. Generally speaking, a persona as used herein is a measurement of numerous criteria associated with the user that reflects certain qualities or aspects of that user that are of interest and that have utility in various types of applications to be discussed herein. In particular, a user may have (at least) four different personas, which are termed an actual persona, an internal perceived persona, an external perceived persona, and an aspirational persona. These various personas utilize overlapping sets of data based upon the qualities of the user that the persona will represent. FIG. 1 is a diagram of the overlapping features of the various personas that are subject of this invention.

A first type of persona that is determined in accordance with this invention is the user's actual persona. The user's actual persona is an analysis and measurement of specific factual data about the user that are easily verified. The actual persona represents, in an unambiguous manner, who the user actually is terms of verifiable data that may be provided by the user as well as obtained from third party resources. This objective data may include but is not limited to any or all of the following information:

name
age/date of birth
address or other geographical information
marital status
gender
amount of income
religion
race
level of education
credit score
occupation

This objective data comprises simple, measurable and verifiable facts about the user and can be analyzed and quantified in order to provide a view of that member that is referred to as his or her actual persona. The algorithmic analysis of this factual data that provide the user's actual persona will be described in further detail below.

Much of the data used to determine the actual persona of a user may be obtained directly from the user in various ways. A questionnaire may be provided that elicits responses from the user, which would be filled in interactively on a user computing device such as a personal computer, mobile device such as an IPHONE, IPAD and the like. In the case of a mobile device, a dedicated app may be employed, or a general browser based form may be used as with the personal computer. Additional user data such as a credit score may be obtained from third party resources such as credit bureaus and the like. In some cases, permission may be required from the user in order to gather the user information from the third party resources, and in some cases permission may not be required. All of the user data that is collected in this manner will be stored at or in association with the persona server computer, typically in a user data database having one or more records for each user in the system.

A second type of persona that is determined in accordance with this invention is the user's internal perceived persona. The internal perceived persona is a measurement of how the user views himself, which may or may not be in accordance with the user's actual persona as described above. In some cases, the user may see himself in accordance with his actual persona, thus leading to the overlapping personas shown by the Venn diagram in FIG. 1. However, in many cases, the user may see himself in a different manner than his actual persona. For example, a user may have an actual persona that indicates he has a low level education, but he may perceive himself to have a much higher level of education.

A third type of persona that is determined in accordance with this invention is the user's external perceived persona. The external perceived persona is a measurement of how others view the user, which may or may not be in accordance with the user's actual persona or internal perceived persona as described above. In some cases, others may see the user in accordance with his actual persona and/or his internal perceived persona, thus leading to the overlapping personas shown by the Venn diagram in FIG. 1. However, in many cases, the user may be seen by others in a different manner than his actual persona and/or his internal perceived persona. For example, a user may have an actual persona that indicates he has a low level of income, but he may be perceived by others to have a much higher level of income.

As will be described further herein, one manner of measuring a user's external perceived persona is to analyze various responses to the user that may be provided by others. That is, a third party's response to a give scenario with respect to the user is determined in whole or in part by how that third party sees the user.

Another means for measuring a user's external perceived persona is to analyze various contextual objects that exist with respect to the user. In this sense, a contextual object is some piece of data that is viewed in context to infer something about an associated user. For example, a photograph posted by a user onto a web site such as FLICKR or through a social networking service such as INSTAGRAM or FACEBOOK may be analyzed in order to infer something about the user that posted the photograph. Image recognition techniques, which are known in the art, may be employed in order to analyze the subject matter of the photos. For example, by using image recognition and analysis, the identities of persons in any photo can be ascertained and logged in memory associated with the user. Other types of information may be inferred from an analysis of the photos, such as whether the subject matter of the photo is business or pleasure, or an analysis of any activities that may be occurring in the photo. In cases where photos are posted on web sites that allow comments by third parties, then those comments that have been posted may be analyzed in order to draw additional inferences about the user. In addition, the number of photos that user may post online may be analyzed to draw further inferences about the user.

A fourth type of persona that is determined in accordance with this invention is the user's aspirational persona. The aspirational persona is an indication of a persona of what the user is aspiring to, which may or may not be in accordance with his actual persona, his internal perceived persona or his external perceived persona. In some cases, the user's aspirational persona may overlap with his actual persona and/or his internal perceived persona and/or his external perceived persona, thus leading to the overlapping personas shown by the Venn diagram in FIG. 1. However, in many cases, the user may have an aspirational persona that is different from his actual persona and/or his internal perceived persona and/or his external perceived persona. For example, a user may have an actual persona that indicates he has a low level of interest in sports, but he may aspire to gain a higher level of interest in sports.

As mentioned above, many types of data may be input to the persona server computer in order to calculate any or all of the actual persona, internal perceived persona, external perceived persona, and/or aspirational persona. This input data will now be discussed.

Data useful for calculating the user's actual persona, as discussed above, could include data received from the user such as name, age/date of birth, address or other geographical information, marital status, gender, amount of income, religion, race, level of education, credit score, occupation, and the like. Also, data about the user may be obtained from third party resources such as a credit score from a credit bureau. Other types of data are useful in inferring things about a user, as now described.

In some embodiments, the user may be a member of one or more social networking services such as FACEBOOK, LINKED IN or the like, which are well known in the art. Social networks that exist on these social networking services are described in detail in my co-pending patent application Ser. No. 13/565,827 entitled METHOD AND SYSTEM FOR IMPLEMENTING A SOCIAL NETWORK PROFILE filed Aug. 3, 2012, the specification of which is incorporated by reference herein. When a user in this invention is also a member of a social network as described therein, information about his social network(s) may be used as input data to the persona analysis. For example, information about other members of the user's social network may be used as input data. This information may include information similar to that used to generate the user's actual persona as described above; to wit, the other members' name, age/date of birth, address or other geographical information, marital status, gender, amount of income, religion, race, level of education, credit score, occupation, and the like.

Additionally, in many social networks there are things that a user can indicate approval of through a like control or something similar. Thus, the user's likes (and/or dislikes) may be recorded and used as input data. In many social networking services, members who are not a part of a user's social network may ask to join that user's social network (i.e. request to friend in FACEBOOK). The acceptance of another member and/or the rejection of another member into a user's social network may thus be used as input data and allow inferences to be made about the user. For example, if a user rejects other members of his social networking service that are shown to have an interest in sports, then it may be inferred that the user has no interest in sports, which may be used in generating the user's external perceived persona.

In one example, the user may be asked to provide a ranking of desirability of other members of the user's social network. Other members who are given a high ranking are weighted more than members who are given a low ranking. As such, certain members of the user's social network who may not share the user's interests are weighted appropriately with respect to those who share the user's interests, such that the various personas that are generated using this information will more accurately reflect the user's friendships, desires, goals and interests.

Additionally, the system may use prior transaction histories as input data in order to generate the various personas described above. Transactions may be financial transactions, purchase transactions for goods and services, and the like. The transactions may occur over the Internet, or at physical locations such as retail stores. This prior transaction history data may be obtained internally from the user, such as through transactions that the user may execute online. Additionally, prior transaction history data may be obtained externally from third party sources such as credit card companies and merchants (user permission may be required in some cases). Other transactions could be web-based transactions that may be tracked online if permission is granted by the user.

Information that is shared online amongst users may be also collected and used as input data for calculating one or more of the personas specified above. In particular, when a user is a member of a social network, he or she usually shares certain information with the other members of his or her network. This selective sharing of information may be monitored (with user permission if required). Of particular interest is the contextual references in the information that is shared on the social network (i.e. what is shared) as well as the identities of the other members in the user's social network with whom that information is shared (i.e. who is sharing).

Third party databases and other repositories of information may also be referenced in order to obtain information that may be used as input data for persona calculations and analysis. Permission to access and use that user data may or may not be required from the user. As previously mentioned, databases such as credit bureaus may be useful in gaining information about the user. Other databases that may be accessed include government databases such as federal databases, state databases, and municipal databases. In addition various workplace databases may be accessed that would have information obtained that is relevant to the user's work environment.

Historical family based information, otherwise known as family trees, are also useful as input data for calculating various personas. Simple familial relationships may be useful, as well as incorporation of persona information from the various members of a user's family tree.

Communications activities undertaken by the user may also be measured and otherwise monitored to be used as input data for persona calculations. Communications may take place with any type of protocol and over any available medium, including but not limited to telephone calls (landline and mobile), email messages, text messages, and the like. Any and all types of information regarding the communications may be gathered and used as input data for the persona calculations. For example, in the case of a telephone transmissions, the input data would include the number of calls made and/or received by the user, the durations of the calls, the other parties in the call, etc. Similar data may be collected for emails, text messages, etc. If desired, the message content may also be analyzed so that certain keywords and triggers are recorded, filtered, collated, etc. and used as data inputs to the persona calculations.

As described above, simple residence information in the form of the user's current address will be used as user input data to the persona algorithms. In addition, advanced residence information is useful for data inputs. Advanced residence information would include the duration of time that the user has been in his or her current residence, if the residence is owned or rented, the number of moves between residences that the user has made in his lifetime, and the time differentials between the various moves he has made. The various locations at which the user has lived may also be useful in the persona calculations and analysis. For example, a user who has always lived in the northern region of the United States will be viewed differently than one who has always lived in the southern region. Likewise, someone who has lived in several different places abroad will have a different set of personas than one who has always lived in the same residence in the U.S.

Once the input data has been collected, then the persona server computer will analyze the various data it has collected and perform the various calculations and algorithmic analyses as will be further described below. In one aspect, personas may be based on measuring differentials in data sets that have been gathered for various users. Differentials may be measured within a user (e.g. differentials over time), or the may be measured amongst various users in a given group of users. Likewise, differentials may be measured between various groups in a given network such as a social network, or even amongst various networks that may exist. Once these data differentials are determined, mathematical values and/or quotients may be assigned to these differentials.

In one embodiment, a social score may be calculated based on the various personas that have been measured for a user. The social score is similar to a credit score and is based on the user's social networks.

In another aspect of the invention, a set of profile markers may be generated, stored, and analyzed. These profile markers are similar to DNA markers in that they inherently define certain characteristics of a user and can be used to match as well as distinguish various users in the same way the DNA markers can. A marker can be tied to individual data points as well as groups of data points that can collectively create a marker. Once the markers are generated for a user, then they can be matched, analyzed, compared, and filtered as may be desired. As such, markers can help to quantify, identify, and measure the personas of a user.

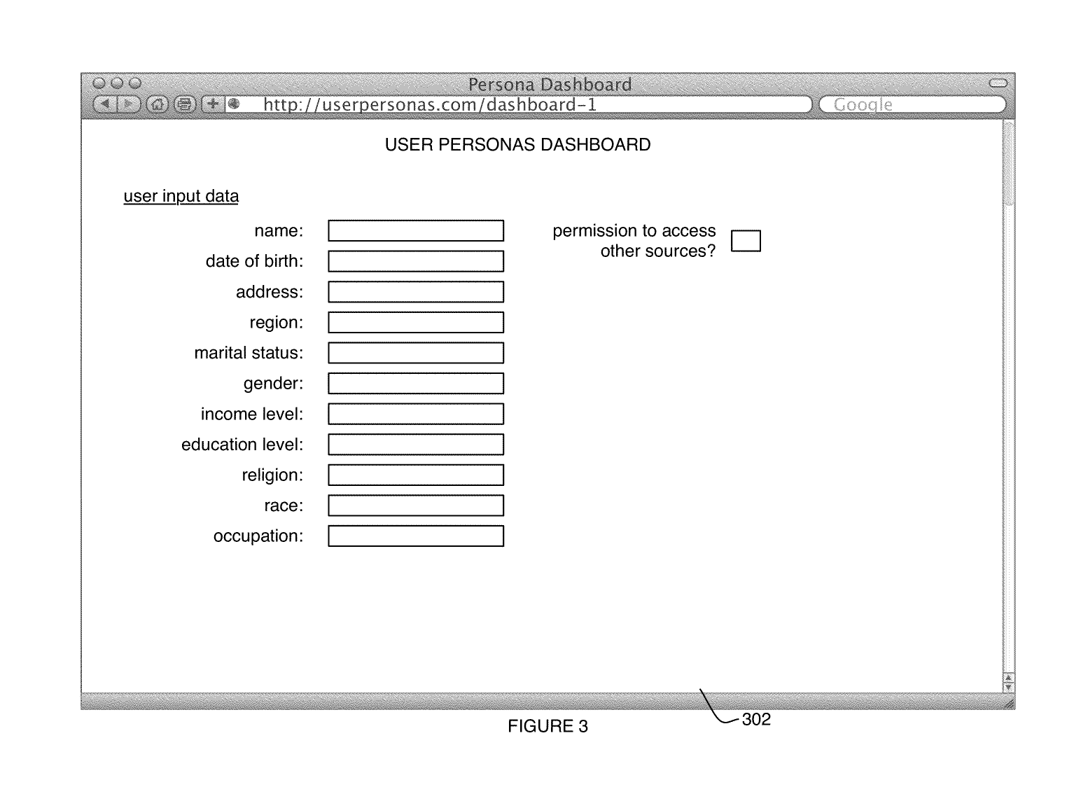

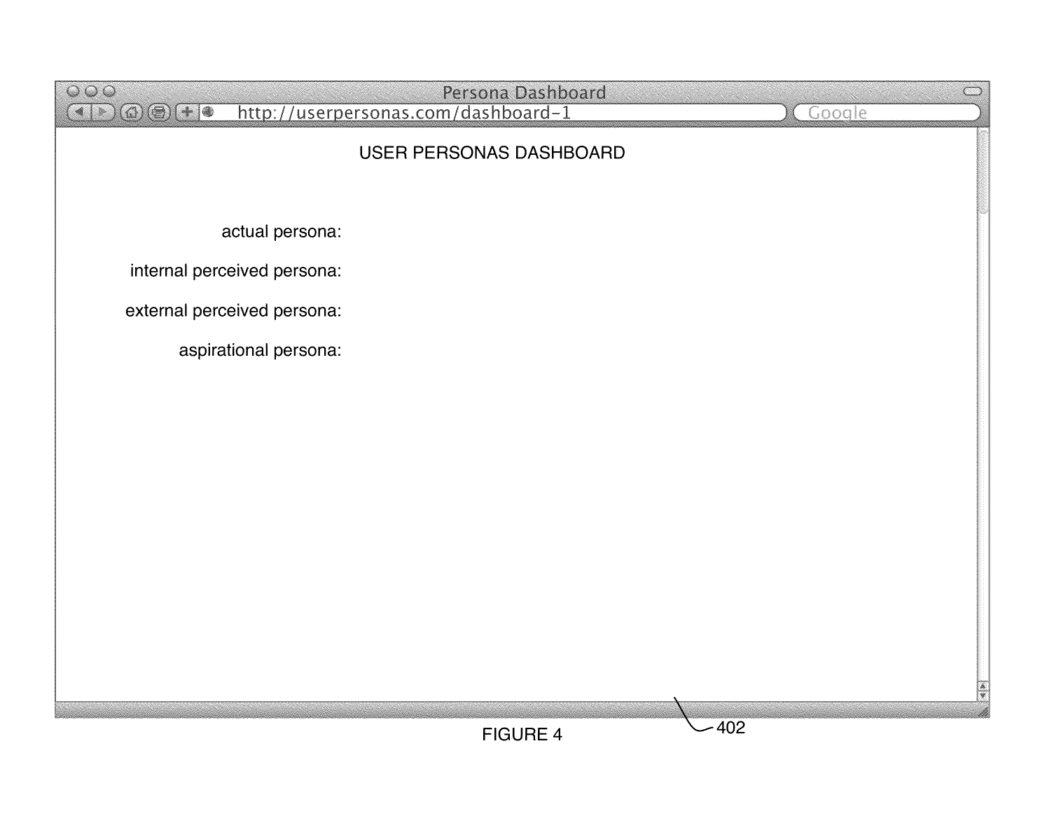

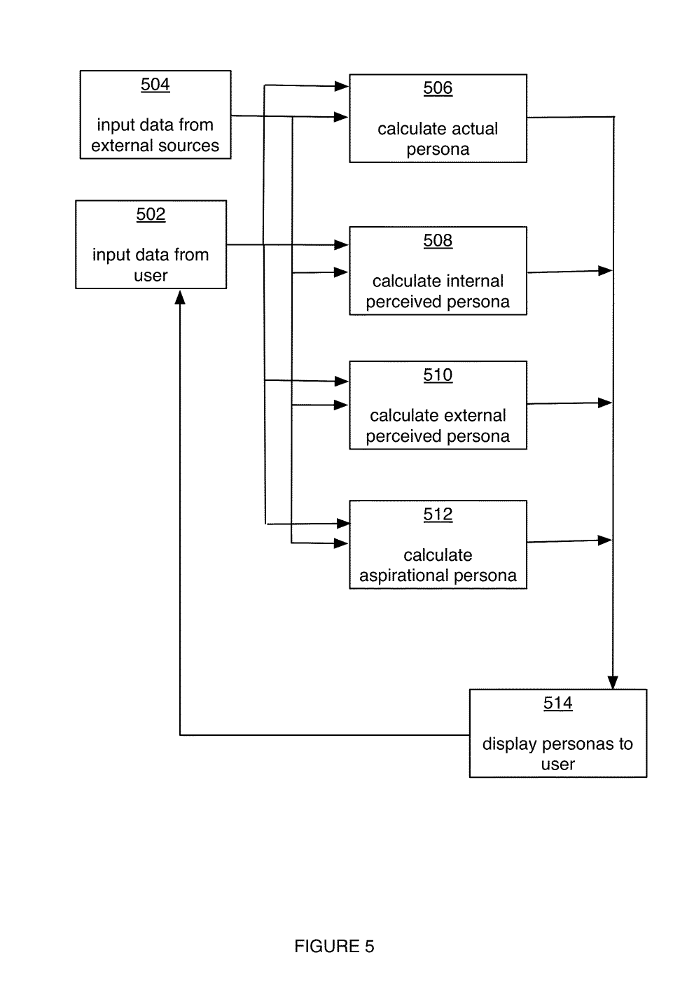

An example of a user interface of the preferred embodiment is shown in FIGS. 3 and 4. The user interface may be presented in a dashboard format, in which various input fields are provided on web page 302 and the results of calculating the four personas are provided on the web page 402. Many other type of inputs and displays as well know in the art may also be used under this invention. Preferably the dashboard is interactive in that the user input controls operate in real time to change the personas as user input data is provided or modified. This provides users with the ability to manage their data so they can control the personas as may be desired.

Numerous commercial applications exist for utilization of the personas calculated under the present invention, including Political Profiling, Intelligence, Security, Law Enforcement, Product Branding, Marketing, Dating Services, Social Networking, Three Dimensional Psychographic Profiling, Travel Recommendations, Gift Recommendations, Celebrity Endorsements (TWITTER), Fraud Prevention, Risk Management, and Corporate Due Diligence.

In another aspect of this invention, rewards (and incentives, collectively referred to as rewards herein) are provided to users based on various criteria related any or all of their four personas. In one embodiment, rewards are provided to a user based on their participation in the system. For example, increased participation may lead to increased rewards provided to the user. In addition, rewards may be based on the personas that are calculated and/or implemented by a third party. For example, a marketing service may offer rewards to a user based on the type of actual persona has attained, and/or based on his external perceived persona, etc. In cases wherein a user is a member of a social network and others in his network are also participants in this system, then rewards may be provided to that user based on the participation by the other members, based on the actual personas of the other members, and the like. The user may elect to share his rewards with other users in his social network if he desires.

Rewards may be provided by the system if a user elects to allow certain types of data to be used for calculating his personas. So, if permission is granted by the user for the system to access third party data sources (such as but not limited to credit bureaus), then increased rewards may be provided to that user. Rewards may be based on both the quantity of the information given as well as the quality (e.g. type of information provided).

What is claimed is:

1. A method for generating a plurality of user personas comprising the steps of
a user inputting, via a user computer, user input data associated with the user;
transmitting the user input data to a persona server computer;
the persona server computer accessing a plurality of external data sources to obtain external user data associated with the user;
the persona server computer using the user input data and the external user data to calculate an actual persona of the user, an internal perceived persona of the user, an external perceived persona of the user, and an aspirational persona of the user;
the persona server computer sending the actual persona of the user, the internal perceived persona of the user, the external perceived persona of the user, and/or the aspirational persona of the user to the user computer for display to the user.

2. The method of claim 1 further comprising generating a persona diagram that illustrates a graphical relationship between the actual persona of the user, the internal perceived persona of the user, the external perceived persona of the user, and/or the aspirational persona of the user, and sending the personal diagram to the user computer for display to the user.

3. The method of claim further comprising the steps of
the user revising the user input data;
transmitting the revised user input data to the persona server computer;
the persona server computer using the revised user input data to revise the actual persona of the user, the internal perceived persona of the user, the external perceived persona of the user, and/or the aspirational persona of the user; and
the persona server computer sending the revised actual persona of the user, the revised internal perceived persona of the user, the revised external perceived persona of the user, and/or the revised aspirational persona of the user to the user computer for display to the user.

4. The method of claim 1 wherein the actual persona of the user is calculated by using factual data associated with the user.

5. The method of claim 1 wherein the internal perceived persona comprises a measurement of how the user views himself.

6. The method of claim 1 wherein the external perceived persona comprises a measurement of how the user is viewed by others.

7. The method of claim 1 wherein the aspirational persona is an indication of a persona of what the user is aspiring to.

8. The method of claim 1 wherein the external user data comprises prior transaction history of the user.

9. The method of claim 1 wherein the external user data comprises social networking information associated with the user.

10. The method of claim 1 wherein the external user data comprises family-based information associated with the user.

11. The method of claim 1 wherein the external user data comprises communications activities associated with the user.
